(19) United States
(12) Patent Application Publication
(10) Pub. No.: US 2014/0232333 A1
(43) Pub. Date: Aug. 21, 2014

(54) ADJUSTING OPERATION OF AN ELECTRONIC DEVICE IN RESPONSE TO A SUDDEN-POWER-OFF (SPO) EVENT

(71) Applicants: JUNHO KIM, Yongin-si (KR); SANGMIN SHIM, Seoul (KR); KEEMOON CHUN, Seongnam-si (KR)

(72) Inventors: JUNHO KIM, Yongin-si (KR); SANGMIN SHIM, Seoul (KR); KEEMOON CHUN, Seongnam-si (KR)

(21) Appl. No.: 14/183,935

(22) Filed: Feb. 19, 2014

(30) Foreign Application Priority Data
Feb. 20, 2013 (KR) 10-2013-0018115

(51) Int. Cl. H02J 7/02; G06F 1/32

(52) U.S. Cl. CPC H02J 7/025; G06F 1/3296
USPC 320/108; 307/43

(57) ABSTRACT

A mobile device includes at least one power source, a sudden-power-off (SPO) estimator, and a system. The SPO estimator is configured to detect a state of the at least one power source, determine a probability of an SPO event occurring, and generate an SPO state signal indicating the determined probability of the SPO event occurring. The system is configured to change an operation mode of the mobile device according to the SPO state signal.

### CROSS-REFERENCE TO RELATED APPLICATIONS

This application claims priority under 35 U.S.C. §119 to Korean Patent Application No. 10-2013-0018115, filed on Feb. 20, 2013, the disclosure of which is incorporated by reference herein in its entirety.

### TECHNICAL FIELD

Exemplary embodiments of the present inventive concept relate to an electronic device, and more particularly, to a mobile device capable of adjusting an operation mode according to the probability of a sudden-power-off event occurring.

### DISCUSSION OF THE RELATED ART

Recently, the use of mobile electronic devices, such as smartphones, tablet computers, digital cameras, MP3 players, and electronic books has been increasing. These various mobile electronic devices use batteries as a power source for receiving necessary power. Since these batteries have limited capacities, the resulting battery life of these mobile devices may be limited. If a sudden-power-off (SPO) event occurs during an important operation process of a mobile device, a critical operation error or data loss may occur.

### SUMMARY

Exemplary embodiments of the present inventive concept include a mobile device for permitting stable operation despite power source errors that may occur due to various causes, and an operation method thereof.

In an exemplary embodiment, a mobile device includes a power source unit including at least one power source, a sudden-power-off (SPO) estimator detecting a state of the at least one power source and determining the probability of an SPO event, and a system changing an operation mode of hardware or software according to the probability of the SPO event.

In an exemplary embodiment, a mobile devices includes a wireless power receiver receiving wireless power, a battery charged with electrical energy output from the wireless power receiver, an SPO estimator generating SPO probability information with reference to the strength of the wireless power or an output of the battery, and an application processor changing at least one of a journaling mode of a file system, a dynamic voltage and frequency scaling (DVFS) mode, and an update period of operating data to a nonvolatile memory.

In an exemplary embodiment, an operating method of a mobile device using any one of a plurality of power sources as a driving power source includes detecting at least one state of the plurality of power sources, determining the probability of an SPO event occurring relating to the driving power source according to the at least one state, and changing a driving mode of hardware or software according to the probability of the SPO event occurring.

In an exemplary embodiment, a mobile device includes at least one power source, a sudden-power-off (SPO) estimator configured to detect a state of the at least one power source, determine a probability of an SPO event occurring, and generate an SPO state signal indicating the determined probability of the SPO event occurring, and a system configured to change an operation mode of the mobile device according to the SPO state signal.

In an exemplary embodiment, a mobile device includes a wireless power receiver configured to wirelessly receive and output wireless power, a rechargeable battery configured to be charged using the wireless power output by the wireless power receiver, and a sudden-power-off (SPO) estimator configured to determine a probability of an SPO event occurring, and generate an SPO state signal indicating the determined probability of the SPO event occurring based on a strength of the wireless power or an output of the rechargeable battery.

In an exemplary embodiment, a method of operating a mobile device includes detecting a state of at least one of a plurality of power sources of the mobile device, wherein the plurality of power sources are each configured to operate as a driving power source of the mobile device, determining a probability of a sudden-power-off (SPO) event occurring at a power source from among the plurality of power sources currently operating as the driving power source according to the detected state, and changing a driving mode of hardware or software of the mobile device according to the determined probability.

In an exemplary embodiment, a method of operating a mobile device using any one of a plurality of power sources as a driving power source, the plurality of power sources include a wireless power source, a rechargeable battery, and a wired power source, the method includes detecting a state of at least one of the plurality of power sources of the mobile device, wherein the plurality of power sources are each configured to operate as a driving power source of the mobile device, determining a probability of a sudden-power-off (SPO) event occurring at a power source from among the plurality of power sources currently operating as the driving power source according to the detected state, and changing a driving mode of hardware or software of the mobile device according to the determined probability.

In an exemplary embodiment, a method of operating a mobile device includes detecting a state of at least one of a plurality of power sources of the mobile device, wherein the plurality of power sources are each configured to operate as a driving power source of the mobile device, determining a probability of a sudden-power-off (SPO) event occurring at a power source from among the plurality of power sources currently operating as the driving power source according to the detected state, and changing a driving mode of hardware or software of the mobile device according to the determined probability, wherein detecting the state of at least one of the plurality of power sources includes detecting whether a lock switch of a battery cover of the mobile device is locked or unlocked.

In an exemplary embodiment, a method of operating a mobile device includes detecting a state of at least one of a plurality of power sources of the mobile device, wherein the plurality of power sources are each configured to operate as a driving power source of the mobile device, determining a probability of a sudden-power-off (SPO) event occurring at a power source from among the plurality of power sources currently operating as the driving power source according to the detected state, and changing a driving mode of hardware or software of the mobile device according to the determined probability, wherein detecting the state of at least one of the plurality of power sources includes detecting whether a lock switch of a battery cover of the mobile device is locked or unlocked, wherein determining the probability includes setting a value of an SPO state signal to a value indicating that the SPO event occurring is probable while the lock switch is unlocked.

In an exemplary embodiment, a method of operating a mobile device includes detecting a state of at least one of a plurality of power sources of the mobile device, wherein the plurality of power sources are each configured to operate as a driving power source of the mobile device, determining a probability of a sudden-power-off (SPO) event occurring at a power source from among the plurality of power sources currently operating as the driving power source according to the detected state, and changing a driving mode of hardware or software of the mobile device according to the determined probability, wherein changing the driving mode includes enabling a journaling mode of a file system upon determining that the probability of the SPO event occurring is probable.

In an exemplary embodiment, a method of operating a mobile device includes detecting a state of at least one of a plurality of power sources of the mobile device, wherein the plurality of power sources are each configured to operate as a driving power source of the mobile device, determining a probability of a sudden-power-off (SPO) event occurring at a power source from among the plurality of power sources currently operating as the driving power source according to the detected state, and changing a driving mode of hardware or software of the mobile device according to the determined probability, wherein changing the driving mode includes changing a dynamic voltage and frequency scaling (DVFS) mode to a low-power mode upon determining that the probability of the SPO event occurring is probable.

In an exemplary embodiment, a method of operating a mobile device includes detecting a state of at least one of a plurality of power sources of the mobile device, wherein the plurality of power sources are each configured to operate as a driving power source of the mobile device, determining a probability of a sudden-power-off (SPO) event occurring at a power source from among the plurality of power sources currently operating as the driving power source according to the detected state, and changing a driving mode of hardware or software of the mobile device according to the determined probability, wherein changing the driving mode includes decreasing an amount of time used to update operating data in a nonvolatile memory upon determining that the probability of the SPO event occurring is probable.

In an exemplary embodiment, a mobile device includes a removable rechargeable battery having a cover and a lock switch disposed on the cover, a sudden-power-off (SPO) estimator configured to determine a probability of an SPO event occurring, and generate an SPO state signal indicating the determined probability of the SPO event occurring, wherein the SPO estimator is configured to determine the probability of the SPO event occurring based on a lock state of the lock switch, wherein the lock state indicates whether the lock switch is locked or unlocked, and a system configured to change an operation mode of the mobile device according to the SPO state signal.

In an exemplary embodiment, a mobile device includes a removable rechargeable battery having a cover and a lock switch disposed on the cover, a sudden-power-off (SPO) estimator configured to determine a probability of an SPO event occurring, and generate an SPO state signal indicating the determined probability of the SPO event occurring, wherein the SPO estimator is configured to determine the probability of the SPO event occurring based on a lock state of the lock switch, wherein the lock state indicates whether the lock switch is locked or unlocked, and a system configured to change an operation mode of the mobile device according to the SPO state signal, wherein the SPO estimator is configured to set a value of the SPO state signal to a value indicating that the SPO event occurring is probable in response to unlocking the lock switch.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram illustrating a mobile device using a power management method, according to an exemplary embodiment of the present inventive concept.

FIG. 2 illustrates a wireless charging type mobile device, according to an exemplary embodiment of the present inventive concept.

FIG. 3 is a block diagram illustrating a configuration of the mobile device in FIG. 2, according to an exemplary embodiment of the present inventive concept.

FIGS. 4A and 4B are flowcharts illustrating exemplary operations of an SPO estimator in FIG. 3, according to exemplary embodiments of the present inventive concept.

FIG. 5 is an exemplary block diagram illustrating a system shown in FIGS. 4A and 4B, according to an exemplary embodiment of the present inventive concept.

FIG. 6 is a flowchart illustrating a method of performing a mode change of a file system according to an SPO state, according to an exemplary embodiment of the present inventive concept.

FIG. 7 is a block illustrating a system, according to an exemplary embodiment of the present inventive concept.

FIG. 8 is a flowchart illustrating performing a dynamic voltage and frequency scaling (DVFS) adjustment according to an SPO state, according to an exemplary embodiment of the present inventive concept.

FIG. 9 is a block diagram illustrating a system, according to an exemplary embodiment of the present inventive concept.

FIG. 10 is a flowchart illustrating an operation of a system in FIG. 9, according to an exemplary embodiment of the present inventive concept.

FIG. 11 is a block diagram illustrating a configuration of a mobile device, according to an exemplary embodiment of the present inventive concept.

FIG. 12 is a flowchart illustrating an operation of the SPO estimator in FIG. 11, according to an exemplary embodiment of the present inventive concept.

FIG. 13 is a block diagram illustrating a mobile device, according to an exemplary embodiment of the present inventive concept.

FIG. 14 is a flowchart illustrating an operation of the SPO estimator in FIG. 13, according to an exemplary embodiment of the present inventive concept.

FIG. 15 is a block diagram illustrating a mobile device, according an exemplary embodiment of the present inventive concept.

FIG. 16 is a flowchart illustrating an operation of the SPO estimator in FIG. 15, according to an exemplary embodiment of the present inventive concept.

FIG. 17 is a block diagram illustrating a mobile terminal, according to an exemplary embodiment of the present inventive concept.

### DETAILED DESCRIPTION OF THE EXEMPLARY EMBODIMENTS

Exemplary embodiments of the present inventive concept will be described more fully hereinafter with reference to the accompanying drawings. Like reference numerals may refer to like elements throughout the accompanying drawings.

For convenience of explanation, exemplary embodiments of the present inventive concept will be described herein with reference to a mobile device. However, it is to be understood that a mobile device is one example for illustrating characteristics and functions of the present inventive concept, and exemplary embodiments are not limited thereto.

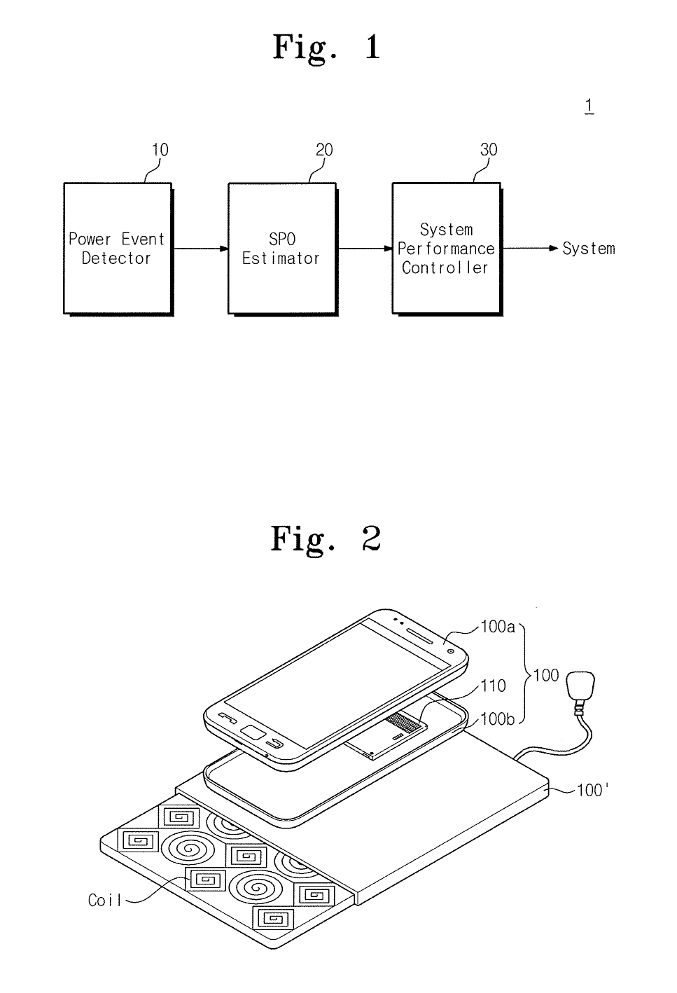

FIG. 1 is a block diagram illustrating a mobile device using a power management method, according to an exemplary embodiment of the present inventive concept. Referring to FIG. 1, the mobile device 1 includes a power event detector 10, a sudden-power-off (SPO) estimator 20, and a system performance controller 30.

The power event detector 10 detects a connection state change of a wired or wireless power source, a charged state change, or a battery level change. For example, the power event detector 10 may detect a symptom of a stage change of a power source. A state change may be, for example, the change between a first state in which the mobile device 1 receives power from the power source, and a second state in which the mobile device 1 does not receive power from the power source (e.g., a battery). For example, the power event detector 10 may predict a battery exchange or a cover separation for the battery exchange. Further, the power event detector 10 may detect a battery level and output a power event signal P_Event. The battery level may be, for example, information indicating an output voltage of the battery. Alternatively, the battery level may be information indicating the remaining charge of a rechargeable battery.

The SPO estimator 20 determines an SPO state SPO_ST of the mobile device 1 with reference to the power event signal P-Event. Herein, reference to the SPO state SPO_ST may refer to an overall SPO state SPO_ST of the mobile device 1, or more specifically, to a corresponding SPO state signal SPO_ST including information indicating the probability that a sudden-power-off event may occur. A sudden-power-off event refers to an event causing the mobile device 1 to lose power as a result of, for example, instability of the power source. For example, when the battery level does not reach a certain reference level, the SPO estimator 20 may output the SPO state signal SPO_ST as probable. However, when the battery level exceeds the reference level, the SPO estimator 20 may output the SPO state signal SPO_ST as improbable. In an exemplary embodiment, the states probable and improbable may be indicated by two values, for example, 0 and 1, which respectively indicate that the occurrence of a sudden-power-off event is probable or improbable. Alternatively, the states probable and improbable may include more than two values, which allows for the indication of the degree of probability and improbability. In an exemplary embodiment, when a lock switch is unlocked from a battery cover, the SPO estimator 20 may predict disconnection of the battery from the mobile device 1, and may output the SPO state signal SPO_ST as probable. Thus, according to exemplary embodiments, the SPO estimator 20 may output the SPO state signal SPO_ST as probable or improbable in response to various types of power events P_Event.

Herein, the SPO state SPO_ST may be referred to as probable when the SPO Estimator 20 determines that the occurrence of a sudden-power-off event is probable, and the SPO state SPO_ST may be referred to as improbable when the SPO Estimator 20 determines that the occurrence of a sudden-power-off event is improbable.

The system performance controller 30 may control the performance of a system with reference to the SPO state SPO_ST. For example, when the SPO state SPO_ST is probable, the system performance controller 30 may convert an operation mode of a file system to a journaling mode. Accordingly, despite the occurrence of a power source error, data can be preserved, as the chance of corruption of data while losing power in the journaling mode is less than the chance of corruption of data while losing power in the file system mode. When the SPO state SPO_ST is improbable, the system performance controller 30 may disable the journaling mode and select a file system mode for providing greater performance. The system performance may be adjusted via a magnitude of a voltage or a frequency of a driving clock. When an SPO event occurs, an update period change for metadata stored in a nonvolatile memory for recovery may correspond to the system performance change.

According to an exemplary embodiment, the probability of an SPO event may be predicted based on the power event P_Event. An operation of a system may be adjusted according to the predicted probability of the SPO event to reduce the chance of a data loss or error occurrence.

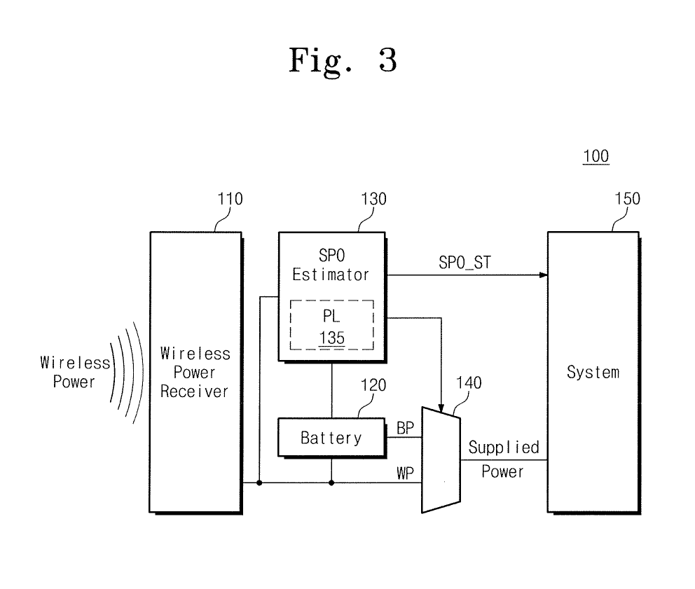

FIG. 2 illustrates a wireless charging type mobile device, according to an exemplary embodiment of the present inventive concept. Referring to FIG. 2, the battery of the mobile device 100 is capable of receiving power and being charged wirelessly via a charging pad 100′.

The battery of the mobile device 100 may be charged using wireless power transmitted from the charging pad 100′. The mobile device 100 converts the wireless power provided from the charging pad 100′ into electrical energy. In addition, the mobile device 100 may perform data processing as well as other operations typically performed (e.g., displaying image data, playing audio/video data, etc.) using the converted energy. The mobile device 100 may include, for example, a main body 100a including a rechargeable battery and a charging case 100b including a wireless power receiver 110, which receives wireless power and converts the wireless power into electrical energy. Alternatively, the wireless power receiver 110 and the charging case 100b may be configured to be included in the main body 100a. The wireless charging type mobile device may utilize, for example, inductive charging, in which the mobile device 100 is charged via a coil of the charging pad 100′.

According to an exemplary embodiment, the mobile device 100 may determine an SPO state SPO_ST with reference to the strength of the wireless power, or a battery level of the battery of the mobile device 100. For example, when the strength of the wireless power is sufficient, but the level of the internal battery is not sufficient, the mobile device 100 may determine that an SPO event may occur at any time (e.g., the SPO_ST may be probable). Accordingly, when the SPO event occurs, the mobile device 100 may operate in a mode for reducing the chance of an error or data loss. Alternatively, when the charged level of the battery is sufficient, it may be determined that the SPO event is not likely to occur (e.g., the SPO_ST is improbable), and that the mobile device 100 may operate in a maximum performance mode.

When wireless charging is utilized, when the mobile device 100 is within a predetermined distance L from the charging pad 100′, or when the mobile device 100 receives wireless power having a strength equal to or greater than a predetermined strength, the battery of the mobile device 100 is charged using the wireless power. In addition, when the charging level of the battery is increased sufficiently, the mobile device 100 may stop charging the battery. Although the mobile device 100 may be within a predetermined distance L from the charging pad 100′, or may receive wireless power having a strength equal to or greater than a predetermined strength, the mobile device 100 may determine that an SPO event is probable when the charging level of the battery is not sufficient. Further, the mobile device 100 may convert an operation mode into a mode better prepared to handle the SPO event.

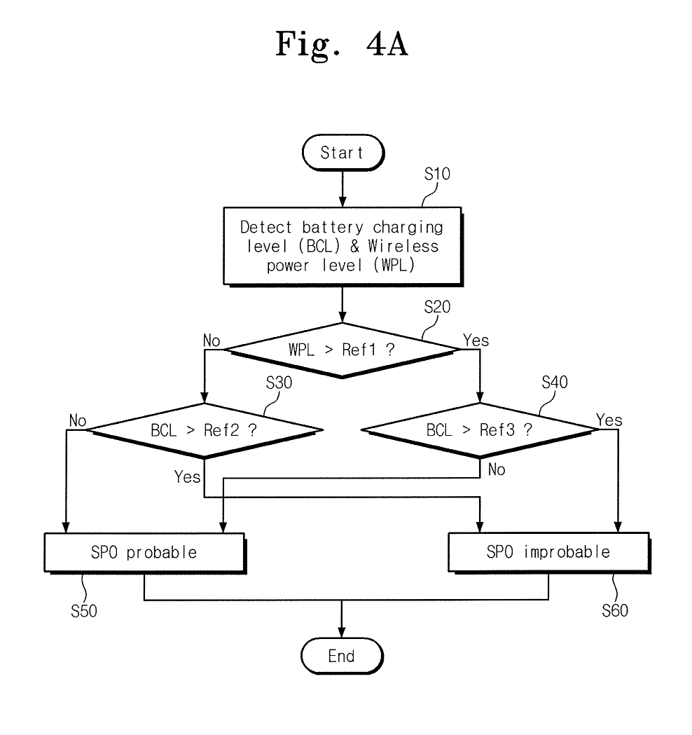

FIG. 3 is a block diagram illustrating a configuration of the mobile device in FIG. 2, according to an exemplary embodiment of the present inventive concept. Referring to FIG. 3, the mobile device 100 includes a wireless power receiver 110, a battery 120, an SPO estimator 130, a power source selector 140, and a system 150. Here, the SPO estimator 130 may determine the SPO state SPO_ST with reference to, for example, a supplying level of wireless power and a charging level of a battery. For convenience of explanation, a description of elements and processes previously described may be omitted.

The wireless power receiver 110 receives wireless power WP and converts the received wireless power WP into electrical energy. The wireless power receiver 110 may convert the wireless power WP transmitted in an electromagnetic wave, or various other forms, into electrical energy. The wireless power WP converted into the electrical energy by the wireless power receiver 110 is provided to the battery 120, the SPO estimator 130, and the power source selector 140.

The battery 120 may receive the wireless power WP and perform a charging operation. The battery 120 may further include a charging circuit for charging power provided from the wireless power receiver 110. The battery 120 may provide a charging level or an output voltage to the SPO estimator 130. The battery 120 may provide the charged battery power BP to the power source selector 140.

The SPO estimator 130 may determine the probability of the occurrence of an SPO event corresponding to the supplied power with reference to the wireless power WP and the level of the battery 120 provided from the wireless power receiver 110. When the battery charging level BCL does not reach a reference level, the SPO estimator 130 may determine that occurrence of the SPO event is probable regardless of a magnitude of the wireless power WP. At this time, the SPO estimator 130 may output the SPO state signal SPO_ST as probable. Alternatively, when the charging level BCL of the battery 120 is equal to the reference level or is greater than the reference level, the SPO estimator 130 may determine that occurrence of the SPO event is improbable. At this time, the SPO estimator 130 may output the SPO state signal SPO_ST as improbable.

The SPO estimator 130 may select supplied power to be provided to the system 150 with reference to the level of wireless power WP and the charging level BCL of the battery 120. When the strength of the wireless power WP is equal to a reference value or is greater than the reference value, the SPO estimator 130 may select the received wireless power WP as the supplied power for the system 150 regardless of the charging level BCL of the battery 120. Alternatively, when the level of the received wireless power WP is less than the reference value, and the charging level BCL of the battery 120 is equal to the reference value or greater than the reference value, the SPO estimator 130 may select battery power BP as the supplied power for the system 150. Further, when the magnitude of each of the battery power BP and the received wireless power WP are both less than the reference value, the SPO estimator 130 may select the wireless power WP as the supplied power of the system 150, and set the SPO state signal SPO_ST as probable.

The criteria for the SPO estimator 130 used to determine the SPO state SPO_ST may vary, and may be defined by a user. The SPO estimator 130 includes program logic PL 135 used to set the criteria for determining the SPO state. Conditions of the SPO estimator 130 may be programmed in the program logic 135.

The power source selector 140 may select any one of the battery power BP and the received wireless power WP as the supplied power for the system 150. In an exemplary embodiment, the power source selection performed by the power source selector 140 may be controlled by separate control logic rather than the SPO estimator 130.

The system 150 may change an operation mode with reference to the SPO state SPO_ST, which may be provided in real-time by the SPO estimator 130. For example, when the probability of an SPO event occurring is high, the system 150 may select an operation mode that minimizes potential damage as a result of the SPO event. For example, when the SPO state SPO_ST is probable, the system 150 may operate in an operation mode more capable of handling occurrence of the SPO event. For example, when the SPO state SPO_ST is probable, the system 150 may enable journaling mode of a file system, as described above. In the journaling mode enable state, the system 150 operates in a mode that reduces the potential of data loss or error occurrence when an SPO event occurs. Alternatively, when the SPO state SPO_ST is improbable, the system 150 may disable the journaling mode. At this time, the system resources may increase as the journaling mode of the file system is disabled. When the journaling mode is disabled, an operation performance of the system 150 may be improved.

In an exemplary embodiment, the system 150 may adjust real-time performance factors such as, for example, adjustment of dynamic voltage frequency scaling, or update period adjustment for a nonvolatile memory according to the SPO state SPO_ST. These operations are described in further detail below.

The system 150 may refer to, for example, an application processor in which various operation processes are performed, an operating system, or an application program. The system 150 may be, for example, a system-on-chip (SoC) that performs a specific algorithm(s) or operation(s). For example, the system 150 may be referred to as a control system capable of controlling at least one aspect of the operation (e.g., hardware or software) of the mobile device 100.

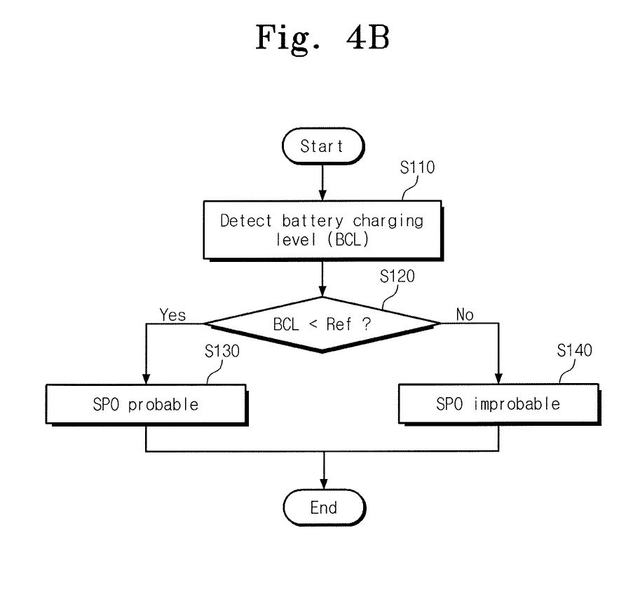

FIGS. 4A and 4B are flowcharts illustrating exemplary operations of the SPO estimator in FIG. 3, according to exemplary embodiments of the present inventive concept. For example, FIG. 4A illustrates an exemplary embodiment of a method of determining the SPO state SPO_ST according to a wireless power level WPL and a charging level BCL of the battery 120 (see FIG. 3). FIG. 4B illustrates an exemplary embodiment of a method of determining the SPO state SPO_ST according to the charging level BCL of the battery 120.

Referring to FIG. 4A, the SPO estimator 130 determines the SPO state SPO_ST with reference to the battery charging level BCL and the received wireless power level WPL. Here, the SPO estimator 130 compares the battery charging level with two reference values Ref2 and Ref3 to determine the SPO state SPO_ST. It is to be understood that as described herein, the value of all reference values may vary, and may be set by a user. Further, it is to be understood that in certain exemplary embodiments according to the flowcharts herein, a determination of which operation to proceed to based on whether a value is equal to a specific reference value (e.g., rather than being greater than or less than the specific reference value) may be reversed.

At operation S10, the SPO estimator 130 detects the battery charging level BCL and the received wireless power level WPL. The battery charging level BCL may be measured, for example, by detecting a charged capacity of the battery 120. For example, the SPO estimator 130 may estimate an open circuit voltage with reference to a time change rate of an output voltage of the battery 120. Further, the SPO estimator 130 may calculate the charging level BCL of the battery 120 using the estimated open circuit voltage. In addition, the wireless power level WPL may be detected by detecting a magnitude of a voltage or a current of the wireless power converted by the wireless power receiving unit 110.

At operation S20, the SPO estimating unit 130 compares the wireless power level WPL with a first reference value Ref1. When the wireless power level is equal to the first reference value Ref1 or less than the first reference value Ref1, the procedure proceeds to operation S30. Alternatively, when the wireless power level WPL is greater than the first reference value Ref1, the procedure proceeds to operation S40.

At operation S30, the SPO estimator 130 compares the battery charging level BCL with the second reference value Ref2. When the battery charging level BCL is equal to the second reference value Ref2 or less than the second reference value Ref2, the procedure proceeds to operation S50, where the SPO state SPO_ST is determined to be probable. When the battery charging level BCL is greater than the second reference value Ref2, the procedure proceeds to operation S60, where the SPO state SPO_ST is determined to be improbable. Thus, in an exemplary embodiment, when the wireless power is not sufficient, the SPO state SPO_ST is determined to be improbable only when the battery charging level exceeds the second reference value Ref2.

At operation S40, the SPO estimator 130 compares the battery charging level BCL with the third reference value Ref3. The third reference value Ref3 is less than the second reference value Ref2. The third reference value Ref3 corresponds to a minimum level of the battery charging level BCL by which the system 150 can be driven for a predetermined time. When the battery charging level BCL is greater than the third reference value Ref3, the procedure proceeds to operation S60. When the battery charging level BCL is equal to the third reference value Ref3 or less than the third reference value Ref3, the procedure proceeds to operation S50.

At operation S50, the SPO estimator 130 determines that the SPO state SPO_ST is probable (e.g., the SPO estimator 130 sets a value of the SPO state signal SPO_ST to a value indicating that the SPO event occurring is probable), and transmits the determined SPO state SPO_ST to the system 150. In addition, at operation S60, the SPO estimator 130 determines the SPO state SPO_ST to be improbable, and transmits the determined SPO state SPO_ST to the system 150.

According to the method of determining the SPO state SPO_ST as described in relation to FIG. 4A, when the wireless power level WPL is insufficient, the battery charging level BCL is compared with the second reference value Ref2 and the SPO state SPO_ST is determined. When the wireless power level WPL is sufficient, the SPO state SPO_ST is determined by comparing the battery charging level BCL with the third reference value Ref3. The third reference value Ref3 is smaller than the second reference value Ref2 and corresponds to a minimal driving condition of the system 150. According to this SPO state SPO_ST determination method, when the battery charging level BCL does not exceed a predetermined value (e.g., Ref3), the SPO event is considered to be able to occur, even though wireless charging is being performed.

Referring to FIG. 4B, the SPO estimator 130 determines the SPO state SPO_ST only on the basis of the charging level BCL of the battery 120. In this case, the SPO estimator 130 determines the SPO state SPO_ST regardless of a magnitude of the wireless power level WPL.

At operation S110, the SPO estimator 130 detects the battery charging level BCL. The battery charging level BCL may be measured, for example, by detecting the remaining charging capacity of the battery 120. Alternatively, the battery charging level BCL may be calculated with reference to a voltage or a voltage change rate from an output terminal of the battery 120.

At operation S120, the battery charging level BCL is compared with a reference voltage. When the battery charging level BCL is less than the reference value Ref, the procedure proceeds to operation S130, where the SPO state SPO_ST is determined to be probable. When the battery charging level BCL is equal to the reference value Ref or greater than the reference value Ref, the procedure proceeds to operation S140, where the SPO state SPO_ST is determined to be improbable.

At operation S130, the SPO estimator 130 determines the SPO state SPO_ST to be probable, and transmits the determined SPO state SPO_ST to the system 150. Further, at operation S140, the SPO estimator 130 determines the SPO state SPO_ST to be improbable, and transmits the determined SPO state SPO_ST to the system 150.

A scheme for estimating the SPO state SPO_ST will be described herein with reference to the charging level of the battery 120 and the wireless power level WPL. However, it is to be understood that exemplary embodiments of the present inventive concept are not limited to the illustrated scheme. Further, methods of determining the SPO state SPO_ST are not limited to the exemplary embodiments described above, and may be variously set. For example, respective reference values for the battery charging level BCL and the wireless power level WPL may be set at a plurality of levels, and the determination of the SPO state SPO_ST may include various levels in various power levels.

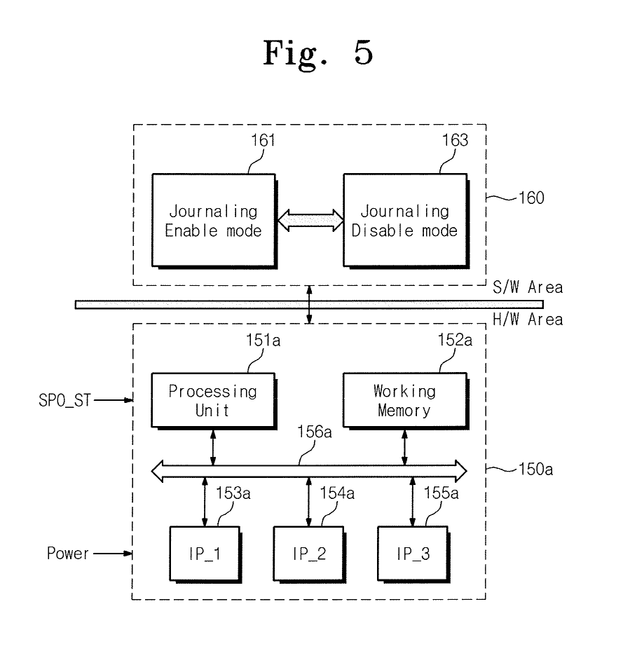

FIG. 5 is an exemplary block diagram illustrating the system shown in FIGS. 4A and 4B, according to an exemplary embodiment of the present inventive concept. Referring to FIG. 5, the system 150a may include a processing unit 151a, a working memory 152a, and a plurality of intellectual property (IP) blocks 153a, 154a, and 155a. A software area for driving the system 150a may include, for example, a file system 160 which is capable of enabling and disabling the journaling mode, as described above.

The processing unit 151a performs operations requested by software or various function blocks. For example, the processing unit 151a may change a driving mode of the system 150a with reference to the SPO state SPO_ST. Alternatively, the processing unit 151a may change the journaling mode of the file system 160 with reference to the SPO state SPO_ST.

When the journaling mode 161 of the file system 160 is enabled, backup and recovery for data being processed is possible, although a power source error or an abnormal termination may occur. When the journaling mode 161 is enabled and a user inputs or amends certain content, the file system 160 records the input or amended content to a log. When the power source error or abnormal termination occurs, the system 150a is rebooted and may be recovered with reference to the recorded content in the log during the rebooting process. Additional system resources may be included, and additional loads may occur in response to recording all input data or updated data in the log.

When the journaling mode is disabled 163, system resources necessary for driving the journaling mode may be saved, and working loads may be reduced. Accordingly, driving performance of the system 150a can be improved.

A change of the journaling mode of the file system 160 will be described herein as an example, however, exemplary embodiments of the present inventive concept are not limited thereto. For example, driving modes of various functional blocks may be converted to a variety of other operation modes (e.g., other than the journaling mode) which are capable of handling errors according to a control of the processing unit 151a.

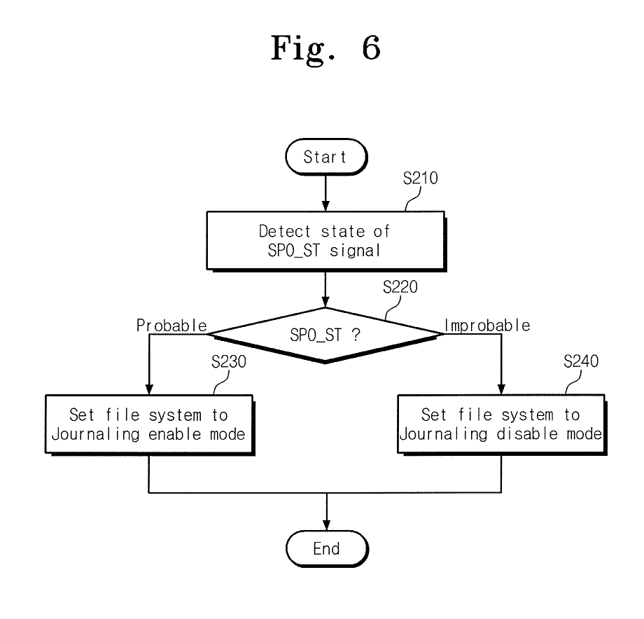

FIG. 6 is a flowchart illustrating a method of performing a mode change of a file system according to the SPO state SPO_ST, according to an exemplary embodiment of the present inventive concept. Referring to FIGS. 5 and 6, the system 150 may switch the journaling mode of the file system with reference to the SPO state SPO_ST.

At operation S210, the system 150a detects the SPO state SPO_ST provided from the SPO estimator 130.

At operation S220, the system 150a performs a branch operation according to the detected SPO state SPO_ST. For example, when the SPO state SPO_ST is probable, the procedure proceeds to operation S230. When the SPO state SPO_ST is improbable, the procedure proceeds to operation S240.

At operation S230, the system 150a (e.g., the processing unit 151a or an operating system OS of the system 150a), sets a driving mode of the file system 160 to a journaling enable mode.

At operation S240, the system 150a (e.g., the processing unit 151a or an operating system OS of the system 150a) sets a driving mode of the file system 160 to a journaling disable mode.

The driving performance of the system 150a, or an exemplary embodiment for a journaling mode change of the file system 160, will be described herein with reference to the SPO state SPO_ST. However, exemplary embodiments of the present inventive concept are not limited thereto. For example, the system 150a (e.g., the operating system or an application program driven in the system 150a) may perform various mode changes with reference to the SPO state SPO_ST.

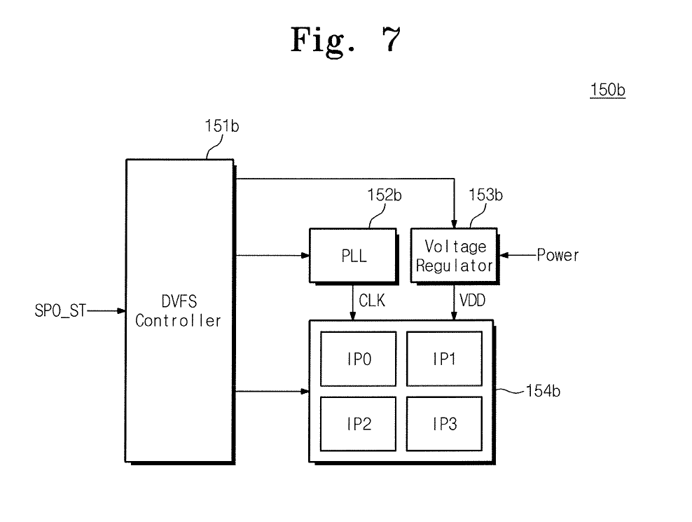

FIG. 7 is a block diagram illustrating a system, according to an exemplary embodiment of the present inventive concept. Referring to FIG. 7, the system 150b includes a dynamic voltage and frequency scaling (DVFS) controller 151b, a phase locked loop 152b, a voltage regulator 153b, and a plurality of functional blocks 154b. The DVFS controller 151b may adjust a clock signal and a driving voltage provided to the plurality of functional blocks 154b with reference to the SPO state SPO_ST.

The DVFS controller 151b may determine performance modes of the plurality of functional blocks 154b with reference to the SPO state SPO_ST. When the SPO state SPO_ST is probable, the DVFS controller 151b may set driving performances of the plurality of functional blocks 154b to be relatively low. Alternatively, when the SPO state SPO_ST is improbable, the DVFS controller 151b may set the driving performances of the plurality of functional blocks 154b to be relatively high. The driving performance change may be performed, by example, by changing a clock frequency of the phase locked loop 152b which generates a clock signal CLK. Further, the driving performance change may be implemented through a level change of the driving voltage VDD provided from the voltage regulator 153b.

The phase locked loop 152b generates a clock signal CLK for driving the plurality of functional blocks 154b. The generated clock signal CLK is provided to the plurality of functional blocks 154b and drives general calculating operations of the plurality of functional blocks 154b. The phase locked loop 152b may be replaced with clock generating circuits of various forms.

The voltage regulator 153b transfers power provided externally to the plurality of functional blocks 154b under the control of the DVFS controller 151b. The voltage regulator 153b adjusts a level of power (or a voltage) provided externally and provides it as a driving voltage VDD of the plurality of functional blocks 154b. The voltage regulator 153b may step-up or step-down an external voltage. For example, when the external voltage is lower than a voltage level VDD (e.g., about 2.0V) required by the system 150b, the voltage regulator 153b may boost the external voltage to provide it to the plurality of functional blocks 154b. When the external voltage is higher than a voltage level required by the plurality of functional blocks 154b, the voltage regulator 153b may drop the external voltage to provide it to the plurality of functional blocks 154b.

The plurality of functional blocks 154b refers to a set of circuits performing various operations according to provided data or control signals, and may include various circuits performing general functions of the system 150b. For example, logic units forming the plurality of functional blocks 154b may include transistors. A driving speed of a transistor may determine the performance of the plurality of functional blocks 154b or the system 150b. The plurality of functional blocks 154b may include, for example, a plurality of IP blocks (IP0, IP1, IP2, and IP3).

Various elements forming the system 150b will be described in further detail herein. It will be understood that some of the elements forming the system 150b may be disposed outside of the system 150b, rather than being formed inside of the system 150b. For example, the voltage regulator 153b may be provided as a separate power device located outside of the system 150b.

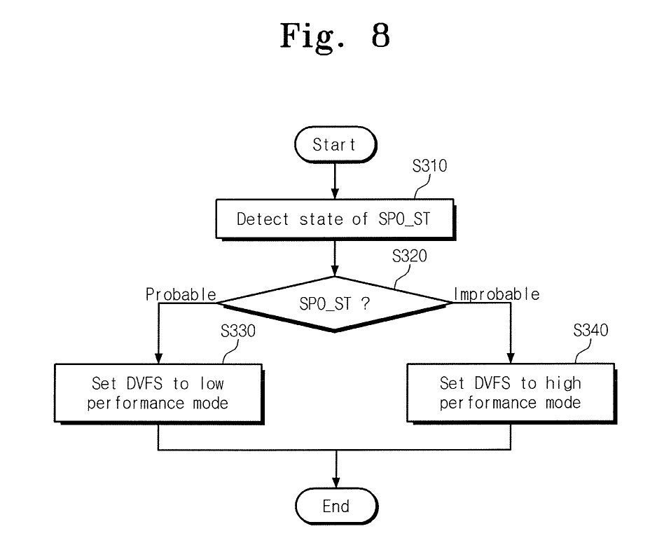

FIG. 8 is a flowchart illustrating performing adjustment of the DVFS according to the SPO state SPO_ST, according to an exemplary embodiment of the present inventive concept. Referring to FIG. 8, the system 150b may change a clock frequency or a driving voltage level with reference to the SPO state SPO_ST.

At operation S310, the DVFS controller 151b detects the SPO state SPO_ST provided by the SPO estimator 130.

At operation S320, the DVFS controller 151b performs a branch operation according to the detected SPO state SPO_ST. For example, when the SPO state SPO_ST is probable, the procedure proceeds to operation S330. When the SPO state SPO_ST is improbable, the procedure proceeds to operation S340.

At operation S330, the DVFS controller 151b may adjust a frequency of a clock signal CLK output from the phase locked loop 152b to be low, corresponding to a low performance mode. Alternatively, the DVFS controller 151b may reduce a level of the driving voltage VDD output from the voltage regulator 153b. The DVFS controller 151b may adjust all levels of the clock signal CLK and the driving voltage VDD.

At operation S340, the DVFS controller 151b may adjust a frequency of a clock signal output from the phase locked loop 152b to be relatively high, corresponding to a high performance mode. Alternatively, the DVFS controller 151b may increase a level of the driving voltage VDD output from the voltage regulator 153b. The DVFS controller 151b may adjust all levels of the clock signal CLK and the driving voltage VDD.

According to the configuration and method of FIGS. 7 and 8 as described above, an exemplary embodiment for adjusting a driving speed or a driving voltage level of the system is described with reference to the SPO state SPO_ST information. When the SPO state SPO_ST is provided as probable, the system 150b may operate in a low speed or low power mode, corresponding to a low performance mode. Alternatively, when the SPO state SPO_ST is provided as improbable, the system 150b may operate at a relatively high speed or a high power mode, corresponding to a high performance mode.

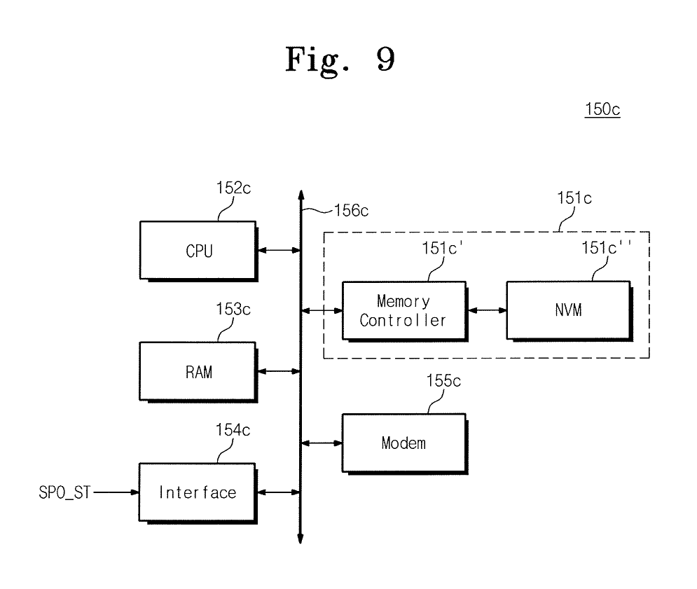

FIG. 9 is a block diagram illustrating a system, according to an exemplary embodiment of the present inventive concept. Referring to FIG. 9, the system 150c includes a central processing unit 152c, RAM 153c, an interface 154c, a modem 155c such as, for example, a baseband chipset, and a storage device 151c, which are electrically connected to each other via a system bus 156c.

The storage device 151c may include, for example, a nonvolatile memory device 151c″ and a memory controller 151c′ for controlling the memory device 151c″. The memory controller 151c′ may include a buffer temporarily storing write request data, and data stored in the buffer may be periodically updated to the nonvolatile memory device 151c″. According to an exemplary embodiment, a period that data is updated to the nonvolatile memory device 151c″ may be variable according to the SPO state SPO_ST. The memory controller 151c′ may adjust the length of the update period with reference to an SPO state SPO_ST input through the interface 154c. For example, the memory controller 151c′ may set the update period to be relatively long when the SPO state SPO_ST is improbable, and relatively short when the SPO state SPO_ST is probable. That is, an amount of time used to update operating data in the nonvolatile memory 151c″ may be decreased when the SPO state SPO_ST is probable.

As the update period becomes shorter, recovery efficiency becomes higher during rebooting, since an amount of data stored in the nonvolatile memory device 151c″ gets larger. However, when the update period is short, an amount of data, which is not dumped to the nonvolatile memory 151c″ from the buffer included in the memory controller 151c′, becomes larger, and this data may be more difficult to recover during rebooting.

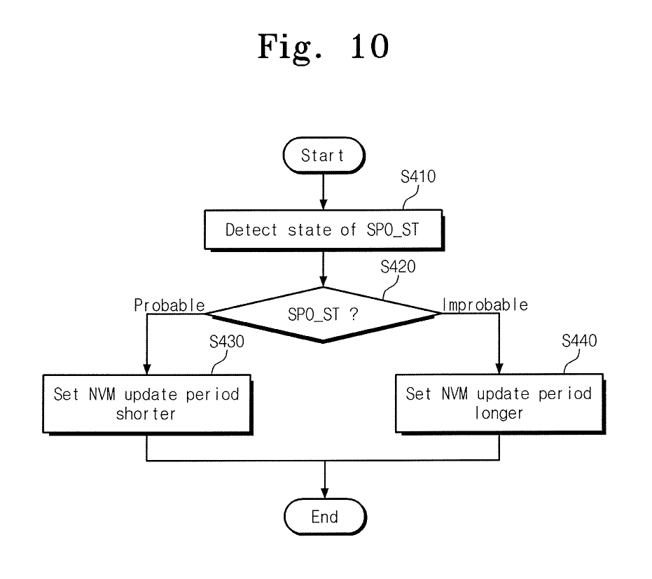

FIG. 10 is a flowchart illustrating an operation of the system of FIG. 9, according to an exemplary embodiment of the present inventive concept. Referring to FIG. 10, the system 150c may change a period of data update to the nonvolatile memory device 151c″ with reference to the SPO state SPO_ST.

For example, at operation S410, the system 150c detects an SPO state SPO_ST provided from the SPO estimator 130. The SPO state SPO_ST information provided from the SPO estimator 130 may be provided to the central processing unit 152c or the memory controller 151c′ through the interface 154c, which may be separately disposed.

At operation S420, the system 150c performs a branch operation according to the detected SPO state SPO_ST. For example, when the SPO state SPO_ST is probable, the procedure proceeds to operation S430. When the SPO state SPO_ST is improbable, the procedure proceeds to operation S440.

At operation S430, the memory controller 151c′ sets the data update period to the nonvolatile memory device 151c″ to be shorter than a reference value. As a result, a storing period of the data retained in the buffer in the memory controller 151c′ to the nonvolatile memory device 151c″ becomes shorter. Accordingly, when a power source error such as an SPO event occurs, the probability of the loss of data stored in the RAM 153c or in the nonvolatile memory, such as an SRAM, may be reduced.

At operation S440, the memory controller 151c′ sets the data update period to the nonvolatile memory device 151c″ to be longer than the reference value. As a result, a movement period of the data retained in the buffer in the memory controller 151c′ to the nonvolatile memory device 151c″ may become relatively longer. In this case, since the probability of an SPO event occurring is nearly zero, resource dissipation or performance degradation due to frequent updates may be prevented.

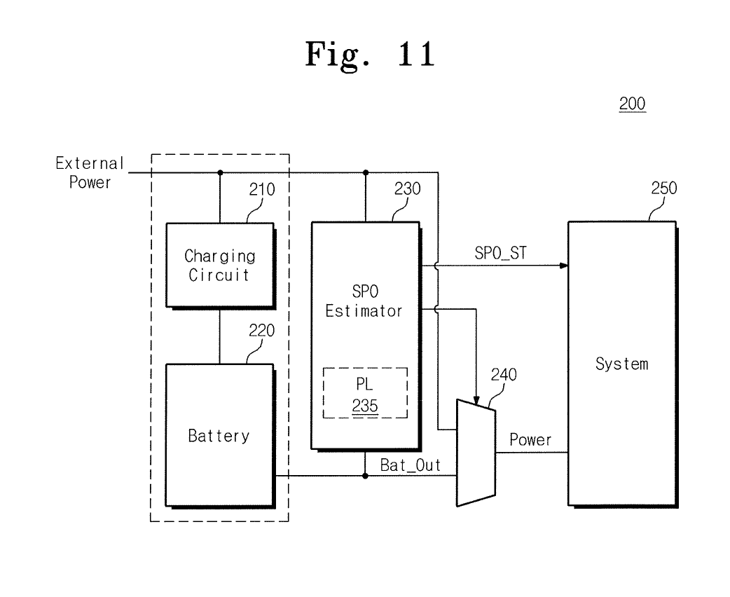

FIG. 11 is a block diagram illustrating a configuration of a mobile device, according to an exemplary embodiment of the present inventive concept. Referring to FIG. 11, the mobile device 200 includes a charging circuit 210, a battery 220, an SPO estimator 230, a power source selector 240, and a system 250. The SPO estimator 230 may determine an SPO state SPO_ST with reference to a state of an external power source and an output Bat_Out of the battery 220.

For example, the charging circuit 210 charges the battery 220 using external power from the external power source. The charging circuit 210 charges the battery 220 to a full level, or a substantially full level, in a state where external power is supplied from the external power source. When the charging level of the battery 220 is lower than the full level, the charging circuit 210 may charge the battery 220 using external power from the external power source. When the charging level of the battery 220 is determined to have reached the full level, the charging circuit 210 stops the charging operation.

The battery 220 is charged under the control of the charging circuit 210. The battery 220 may be, for example, a non-removable internal battery disposed in the mobile device 200, or a removable/external battery.

The SPO estimator 230 determines the probability of an SPO event occurring regarding the supplied power with reference to the charging level of the battery 200 and the external power from the external power source. When the charging level BCL of the battery 220 does not reach the reference value, the SPO estimator 230 determines that there is a probability of an SPO event occurring, regardless of a level of the external power supplied by the external power source. At this time, the SPO estimator 230 may output the SPO state SPO_ST as probable. Alternatively, when the charging level BCL of the battery 220 is equal to the reference value or greater than the reference value, the SPO estimator 230 determines that the occurrence of an SPO event is improbable. At this time, the SPO estimator 230 may output the SPO state SPO_ST as improbable.

The SPO estimator 230 may select the manner of supplying power provided to the system 250 with reference to the external power from the external power source and the charging level of the battery. When the level of the external power from the external power source is equal to the reference value or greater than the reference value, the SPO estimator 230 may select the external power source as the source for supplying power to the system 250 regardless of the charging level of the battery. Alternatively, when the level of the external power from the external power source is less than the reference value and the charging level of the battery 220 is equal to the reference value or greater than the reference value, the SPO estimator 230 may select the battery output Bat_Out as the source for supplying power to the system 250. Further, when both the levels of the battery 220 and the external power source are less than the reference value, the SPO estimator 230 selects any one of the external power source and the battery output Bat_Out as the source for supplying power, and may set the SPO state SPO_ST to probable.

Criteria for determining the SPO state SPO_ST by the SPO estimator 230 may vary, and may be set by a user. For example, the SPO estimator 230 may include program logic 235 for setting the criteria for determining the SPO state SPO_ST. The criteria of the SPO estimator 230 may be programmed to the program logic 235.

The power source selector 240 selects any one of the external power source and the battery output Bat_Out as the source for supplying power.

The system 250 may change an operation mode with reference to the SPO state SPO_ST. For example, when there is a high probability that an SPO event will occur (e.g., when the SPO state SPO_ST is probable), the system 250 may be driven in an operation mode capable of handling the occurrence of the SPO event. For example, when the SPO state SPO_ST is probable, the system 250 may enable the journaling mode of the file system, as described above. Alternatively, when the SPO state SPO_ST is improbable, the system 250 may disable the journaling mode, as described above. Further, the system 250 may perform operations, for adjusting in real-time, performance factors such as the DVFS adjustment, or update period adjustment to the nonvolatile memory according to the SPO state SPO_ST.

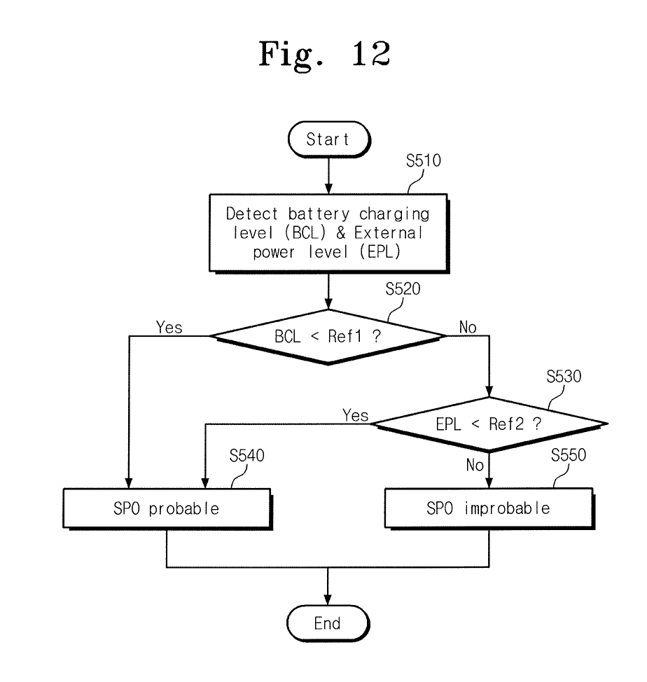

FIG. 12 is a flowchart illustrating an exemplary operation of the SPO estimator in FIG. 11, according to an exemplary embodiment of the present inventive concept. Referring to FIG. 12, the SPO estimator 230 determines the SPO state SPO_ST with reference to the charging level BCL of the battery 220 and the external power level EPL.

At operation S510, the SPO estimator 230 detects the battery charging level BCL and the external power level EPL. The battery charging level BCL may be measured, for example, by detecting the charging capacity of the battery 220. For example, the SPO estimator 230 may estimate an open circuit voltage with reference to a time change rate of the output voltage Bat_Out of the battery 220. Further, the SPO estimator 230 may determine the charging level BCL of the battery 220 using the estimated open circuit voltage.

At operation S520, the SPO estimator 230 compares the battery charging level BCL with a first reference value Ref1. When the battery charging level BCL is less than the first reference value Ref1, the procedure proceeds to operation S540, where it is determined that the occurrence of an SPO event is probable, and thus, the SPO state SPO_ST is set to probable. When the battery charging level BCL is equal to the first reference value Ref1 or greater than the first reference value Ref1, the procedure proceeds to operation S530, where the SPO state SPO_ST is determined with reference to the external power level EPL.

At operation S530, the SPO estimator 230 compares the external power level EPL with a second reference value Ref2. When the external power level is less than the second reference value Ref2, the procedure proceeds to operation S540. When the battery charging level BCL is equal to the second reference value Ref2 or greater than the second reference value Ref2, the procedure proceeds to operation S550. Here, the second reference value Ref2 may be a reference value of the external power source which is capable of charging the battery 220.

At operation S540, the SPO state SPO_ST is determined to be probable. At operation S550, the SPO state SPO_ST is determined to be improbable.

A scheme of estimating the SPO state SPO_ST in the system 250 will be described herein with reference to the charging level BCL of the battery 220 and the external power level EPL. However, exemplary embodiments of the present inventive concept are not limited to the illustrated method. For example, in an exemplary embodiment, the SPO state SPO_ST may be determined based only on the battery charging level BCL, regardless of the external power level EPL.

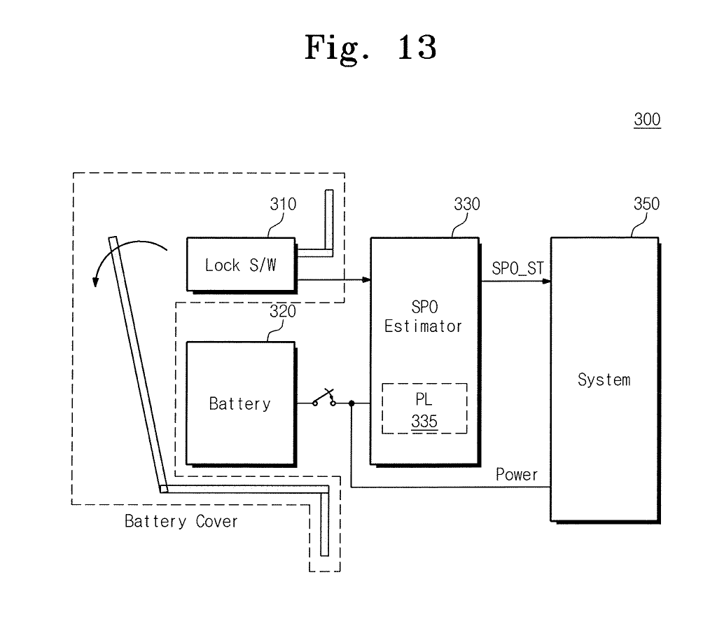

FIG. 13 is a block diagram illustrating a mobile device, according to an exemplary embodiment of the present inventive concept. Referring to FIG. 13, the mobile device 300 includes a lock switch 310, a battery 320, an SPO estimator 330, and a system 350. The lock switch 310 is provided to fix or separate a battery cover. For example, to open the battery cover, the lock switch 310 is first unlocked. The SPO estimator 330 may determine the SPO state SPO_ST with reference to whether the lock switch is locked or unlocked.

In an exemplary embodiment, the lock switch 310 may be a part of the battery cover. After the lock switch 310 is unlocked, the battery cover protecting the battery 320 may be separated. Once the battery cover is separated, the battery 320 may be removed. Whether the lock switch 310 is locked or unlocked may be detected using an electrical signal that is provided to the SPO estimator 330. For example, when a user unlocks the lock switch 310 to remove the battery 320, information indicating the current state of the lock switch 310 (e.g., information indicating that the lock switch 310 is unlocked) may be provided to the SPO estimator 330 via an electrical signal.

In an exemplary embodiment utilizing the lock switch 310, the battery 320 is a removable battery which may be inserted into and removed from the mobile device 300. Output terminals of the battery 320 may be respectively connected to the SPO estimator 330 and the system 350.

The SPO estimator 330 determines the probability of the occurrence of an SPO event with reference to the lock/unlock state of the lock switch 310 and a charging level of the battery 320. For example, when the charging level BCL of the battery 320 does not reach a reference value, the SPO estimator 330 determines that there is a high probability of an SPO event occurring. As a result, the SPO estimator 330 may output the SPO state SPO_ST as probable. Alternatively, when the charging level BCL of the battery 320 is equal to the reference value or greater than the reference value, the SPO estimator 330 may determine that the probability of an SPO event occurring is low. As a result, the SPO estimator 330 may output the SPO state SPO_ST as improbable.

For example, when the charging level of the battery 320 is sufficient but the lock switch is unlocked, the SPO estimator 230 may output the SPO state SPO_ST as improbable, regardless of the charging level of the battery 320. The criteria for determining the SPO state SPO_ST by the SPO estimator 330 may vary, and may be set by a user. The SPO estimator 130 includes a program logic PL 335 for setting the criteria for determining the SPO state. Operating conditions of the SPO estimator 130 may be programmed to the program logic 335 by the user.

The system 350 may change an operating mode with reference to the SPO state SPO_ST. As described above, the system 350 may perform a journaling mode change, a DVFS adjustment, and adjustment of the data update period to the nonvolatile memory according to the SPO state SPO_ST. The operating mode change is not limited to the above-described examples.

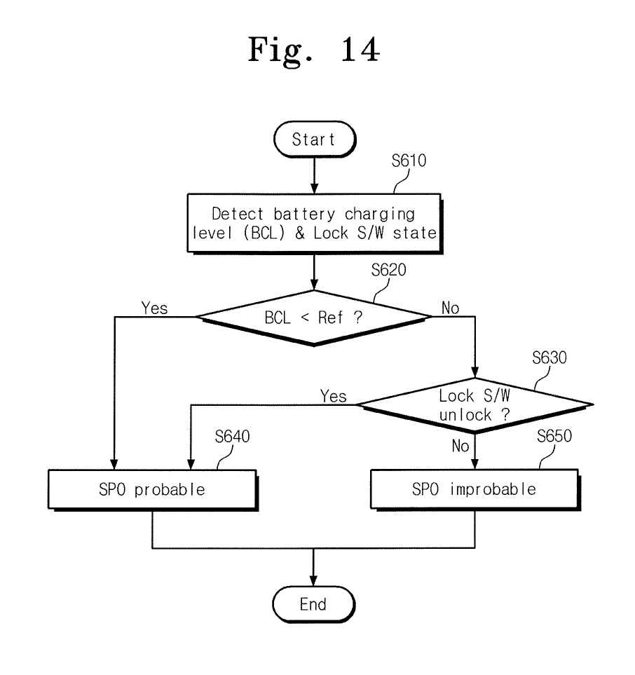

FIG. 14 is a flowchart illustrating an exemplary operation of the SPO estimator in FIG. 13, according to an exemplary embodiment of the present inventive concept. Referring to FIG. 14, the SPO estimator 330 determines an SPO state SPO_ST according to the charging level of the battery 320, and the status (e.g., lock/unlock) of the lock switch 310.

At operation S610, the SPO estimator 330 detects a state of the lock switch 310 and the battery charging level BCL. The state of the lock switch 310 may be determined with reference to an electrical signal which is changed according to the status (e.g., locked or unlocked) of the lock switch 310, as described above. The battery charging level BCL may be measured, for example, by detecting an output voltage of the battery 320 or the remaining charge of the battery 320.

At operation S620, the SPO estimator 330 compares the battery charging level BCL with a reference value Ref. When the battery charging level BCL is less than the reference value Ref, the procedure proceeds to operation S640, where the SPO state SPO_ST is determined to be probable. When the battery charging level BCL is equal to the reference value Ref or greater than the reference value Ref, the procedure proceeds to operation S630, where the state of the lock switch 310 is determined.

At operation S630, the SPO estimator 330 detects that the lock switch is in an unlock state. When the lock switch 310 is in the unlock state, the procedure proceeds to operation S640. That is, because the lock switch 310 is moved to the unlock state (e.g., either intentionally to separate the battery 320 or unintentionally), it is determined that an SPO event may be about to occur. When the lock switch 310 is in a lock state, the procedure proceeds to operation S650, where it is determined that the SPO state SPO_ST is improbable.

Thus, at operation S640, the SPO state SPO_ST is determined to be probable, and at operation S650, the SPO state SPO_ST is determined to be improbable. At this time, the system 350 changes or retains internal driving conditions according to the SPO state SPO_ST.

A scheme of determining the SPO state SPO_ST according to the battery charging level BCL and the lock/unlock state of the lock switch 310 will be described herein.

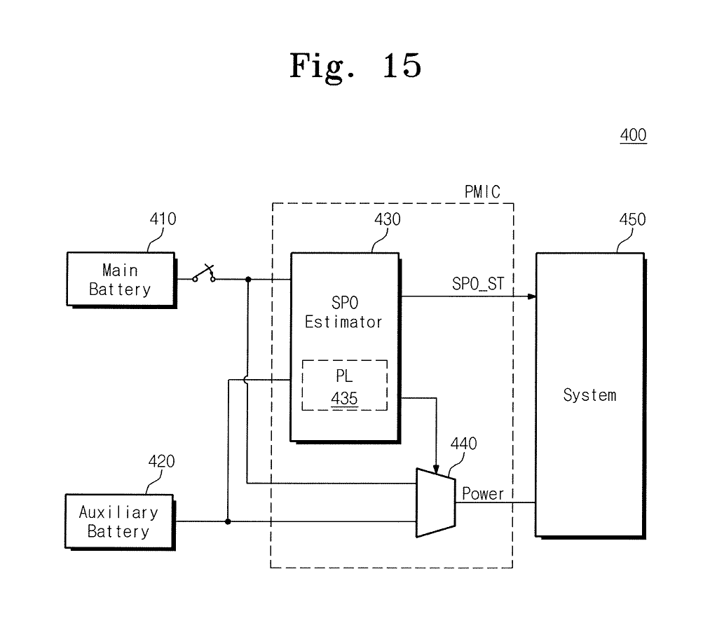

FIG. 15 is a block diagram illustrating a mobile device, according to an exemplary embodiment of the present inventive concept. Referring to FIG. 15, the mobile device 400 includes a removable main battery 410 and an internal (e.g., built-in) auxiliary battery 430, which is not removable. An SPO estimator 430 may determine an SPO state SPO_ST according to the states of the two batteries 410 and 420. The SPO estimator 430 and the power source selector 440 may be disposed in a power management IC (PMIC).

The main battery 410 may be rechargeable. The main battery 410 may be mounted in a space in the mobile device 400 specifically designed to house the main battery 410, which may be separate from other components of the mobile device 400. To protect the main battery 410, a battery cover may be further included. Output terminals of the main battery 410 are connected to the SPO estimator 430 and the power source selector 440.

The auxiliary battery 420 may be a non-removable internal (e.g., built-in) battery, and may be rechargeable. However, the auxiliary battery 420 is not limited thereto. For example, the auxiliary battery 420 may be a non-rechargeable and/or removable battery. Output terminals of the auxiliary battery 420 are connected to the SPO estimator 430 and the power source selector 440.

The SPO estimator 430 determines the SPO state SPO_ST based on whether the main battery 410 and the auxiliary battery 420 are connected, and/or based on output levels of the main battery 410 and the auxiliary battery 420. When an output of the auxiliary battery 420 is equal to a predetermined level or greater than a predetermined level, the SPO estimator 430 outputs the SPO state SPO_ST as improbable. For example, in an exemplary embodiment, when an output voltage level of the auxiliary battery 420 is about 3.3V or greater, the SPO estimator 430 may output the SPO state SPO_ST as improbable, and when the output voltage level of the auxiliary battery 420 is less than about 3.3V, the SPO estimator 430 may output the SPO state SPO_ST as probable.

The SPO estimator 430 may select any one of the main battery 410 and the auxiliary battery 420 as the source for supplying power to the system 450 with reference to the output level and/or a connection state of the main battery 410. For example, when the main battery 410 is removed or the output voltage level of the main battery 410 is less than a reference value, the SPO estimator 430 may control the power source selector 440 to select an output from the auxiliary battery 420.

Criteria for determining the SPO state SPO_ST by the SPO estimator 430 may vary, and may be set by a user. The SPO estimator 430 includes a program logic 435 for setting the criteria for determining the SPO state. Conditions of the SPO estimator 430 may be programmed to the program logic 435 by the user.

The power source selector 440 may select any one of outputs of the main battery 410 and the auxiliary battery 420 under the control of the SPO estimator 430.

The system 450 may change an operation mode with reference to the SPO state SPO_ST. For example, when the probability of an SPO event occurring is high, the system 450 may be driven in an operation mode capable of handling the SPO event. For example, the system 450 may enable the journaling mode of the file system when the SPO state SPO_ST is probable, as described above. Thus, if an SPO event occurs while the journaling mode is enabled, the system 250 may operate in a state capable of reducing data loss or error occurrence. Alternatively, when the probability of an SPO event occurring is low, the system 450 may disable the journaling mode.

Further, the system 450 may adjust, in real-time, performance factors such as a DVFS adjustment, or update period adjustment for a nonvolatile memory according to the SPO state SPO_ST, as described above.

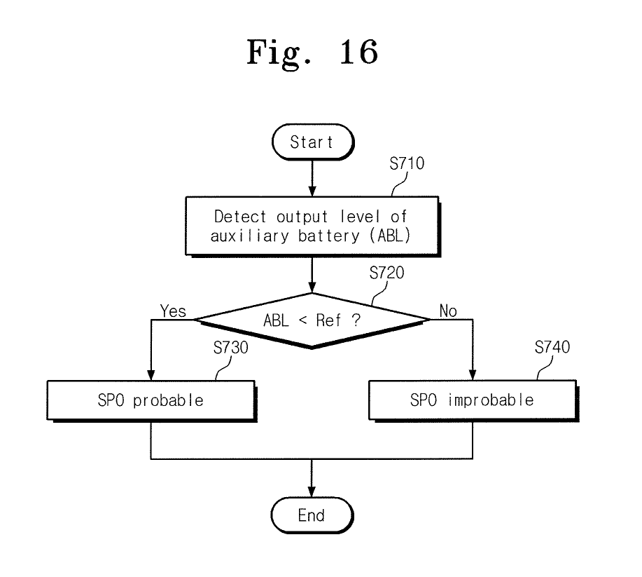

FIG. 16 is a flowchart illustrating an exemplary operation of the SPO estimator in FIG. 15, according to an exemplary embodiment of the present inventive concept. Referring to FIG. 16, the SPO estimator 430 compares an output level ABL of the auxiliary battery 420 with a reference value Ref to determine the SPO state SPO_ST.

At operation S710, the SPO estimator 430 detects an output level ABL of the auxiliary battery 420. The output level ABL of the auxiliary battery 420 may be measured, for example, by detecting the remaining charge or the level of an output voltage of the auxiliary battery 420. For example, the SPO estimator 430 may calculate an open circuit voltage with reference to an output voltage or a time change rate of an output voltage of the auxiliary battery 420. Further, the SPO estimator 430 may estimate an output level ABL of the auxiliary battery 420 by using the calculated open circuit voltage.

At operation S720, the SPO estimator 430 compares the output level ABL of the auxiliary battery 420 with the reference value Ref. When the output level ABL of the auxiliary battery 420 is less than the reference value Ref, the procedure proceeds to operation S730, where it is determined that the SPO state is probable. When the output level ABL of the auxiliary battery 420 is equal to the reference value Ref or greater than the reference value Ref, the procedure proceeds to operation S740, where it is determined that the SPO state SPO_ST is improbable.

At operation S730, the SPO state SPO_ST is determined to be probable. At operation S740, the SPO state SPO_ST is determined to be improbable.

A scheme of estimating the SPO state SPO_ST in the system 450 in FIG. 15 will be described herein with reference to the charging level BCL of the auxiliary battery 420. However, exemplary embodiments of the present inventive concept are not limited to the illustrated scheme. For example, the SPO state SPO_ST may be determined based on whether the main battery 410 is attached or detached to the mobile device 400 and the output level thereof.

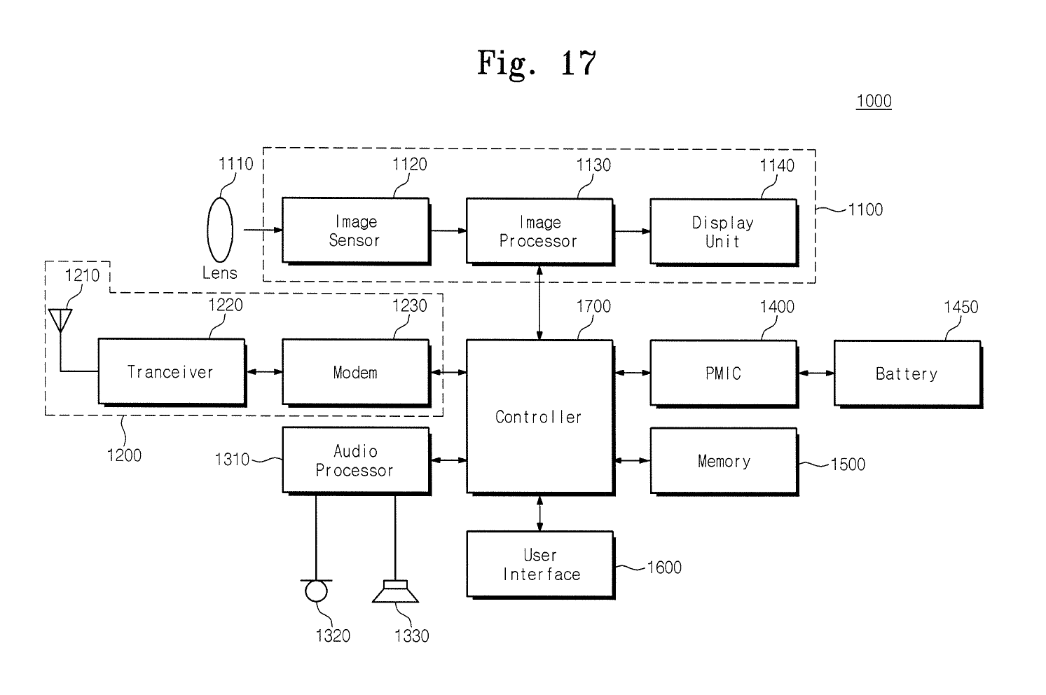

FIG. 17 is a block diagram illustrating a mobile terminal, according to an exemplary embodiment of the present inventive concept. Referring to FIG. 17, the mobile terminal 1000 according to an exemplary embodiment may include an image processor 1100, a wireless transmitter and receiver 1200, an audio processor 1310, a power management IC (PMIC) 1400, a battery 1450, a memory 1500, a user interface 1600, and a controller 1700.

The image processor 1100 includes a lens 1110, an image sensor 1120, an image processor 1130, and a display 1140. The wireless transmitter and receiver 1200 includes an antenna 1210, a transceiver 1220, and a modem 1230. The audio processor 11310 is connected to a microphone 1320, and a speaker 1330.

For example, the PMIC 1400 may provide information regarding the probability of the occurrence of an SPO event with reference to an output voltage or remaining charge of the battery 1450. Here, the probability information regarding the potential occurrence of an SPO event corresponds to the SPO state SPO_ST. For example, when the battery 1450 is charged by the external power source via a wired or wireless scheme, the PMIC 1400 may determine the SPO state SPO_ST with reference to a level of the external power source and an output voltage of the battery 1450. Further, the controller 1700 may change an operation mode or a driving mode of software with reference to the SPO state SPO_ST provided by the PMIC 1400.

According to an exemplary embodiment of the present inventive concept, a mobile device which enables various handling operations for responding to the probability of the occurrence of sudden-power-off (SPO) events of a power source is provided, resulting in a mobile device having improved stability.

While the present inventive concept has been particularly shown and described with reference to the exemplary embodiments thereof, it will be understood by those of ordinary skill in the art that various changes in form and detail may be made therein without departing from the spirit and scope of the present inventive concept as defined by the following claims.

What is claimed is:

1. A mobile device, comprising:
at least one power source;
a sudden-power-off (SPO) estimator configured to detect a state of the at least one power source, determine a probability of an SPO event occurring, and generate an SPO state signal indicating the determined probability of the SPO event occurring; and
a system configured to change an operation mode of the mobile device according to the SPO state signal.

2. The mobile device of claim 1, wherein the at least one power source comprises:
a rechargeable battery; and
a wireless power receiver configured to receive wireless power and provide the received wireless power to the rechargeable battery.

3. The mobile device of claim 2, wherein the SPO estimator is configured to set a value of the SPO state signal to a value indicating that the SPO event occurring is probable while an output value of the rechargeable battery is less than a reference value.

4. The mobile device of claim 2, wherein the SPO estimator is configured to set a value of the SPO state signal to a value indicating that the SPO event occurring is improbable while a level of the wireless power is equal to or less than a first reference value and an output of the rechargeable battery is greater than a second reference value.

5. The mobile device of claim 4, wherein the SPO estimator is configured to set the value of the SPO state signal to a value indicating that the SPO event occurring is probable while the level of the wireless power is equal to or less than the first reference value and the output of the rechargeable battery is less than the second reference value.

6. The mobile device of claim 4, wherein the SPO estimator is configured to set the value of the SPO state signal to a value indicating that the SPO event occurring is probable while the level of the wireless power is greater than the first reference value and the output of the rechargeable battery is less than a third reference value, wherein the third reference value is less than the second reference value.

7. The mobile device of claim 6, wherein the SPO estimator is configured to set the value of the SPO state signal to the value indicating that the SPO event occurring is improbable while the level of the wireless power is greater than the first reference value and the output of the rechargeable battery is equal to or greater than the third reference value.

8. The mobile device of claim 1, wherein the system is configured to switch from a file system mode of an operating system of the mobile device to a journaling mode of the operating system while a value of the SPO state signal indicates that the SPO event occurring is probable.

9. The mobile device of claim 1, wherein the system is configured to switch from a dynamic voltage and frequency scaling (DVFS) mode to a low-power mode while a value of the SPO state signal indicates that the SPO event occurring is probable.

10. The mobile device of claim 1, wherein the system is configured to decrease an amount of time used to update operating data in a nonvolatile memory while a value of the SPO state signal indicates that the SPO event occurring is probable.

11. The mobile device of claim 1, wherein the at least one power source comprises a removable battery having a cover and a lock switch disposed in the cover, and the SPO estimator is configured to determine the probability of the SPO event occurring based on an output of the battery or a lock state of the lock switch, wherein the lock state indicates whether the lock switch is locked or unlocked.

12. The mobile device of claim 11, wherein the SPO estimator is configured to set a value of the SPO state signal to a value indicating that the SPO event occurring is probable in response to unlocking the lock switch.

13. The mobile device of claim 1, wherein the at least one power source comprises:
a removable main battery; and
a non-removable auxiliary battery disposed within the mobile device,
wherein the SPO estimator is configured to determine the probability of the SPO event occurring according to an output of the non-removable auxiliary battery.

14. The mobile device of claim 1, wherein the SPO estimator comprises program logic configured to store data indicating a procedure used to detect the state of the at least one power source.

15. A mobile device, comprising:
a wireless power receiver configured to wirelessly receive and output wireless power;
a rechargeable battery configured to be charged using the wireless power output by the wireless power receiver; and
a sudden-power-off (SPO) estimator configured to determine a probability of an SPO event occurring, and generate an SPO state signal indicating the determined probability of the SPO event occurring based on a strength of the wireless power or an output of the rechargeable battery.

16. The mobile device of claim 15, further comprising:
an application processor configured to switch from a file system mode of an operating system of the mobile device to a journaling mode of the operating system while a value of the SPO state signal indicates that the SPO event occurring is probable, switch from a dynamic voltage and frequency scaling (DVFS) mode to a low-power mode while the value of the SPO state signal indicates that the SPO event occurring is probable, or decrease an amount of time used to update operating data in a nonvolatile memory while the value of the SPO state signal indicates that the SPO event occurring is probable.

17. The mobile device of claim 15, wherein the SPO estimator is configured to set a value of the SPO state signal to a value indicating that the SPO event occurring is improbable while the strength of the wireless power is less than a first reference value and the output of the battery is equal to or greater than a second reference value.

18. The mobile device of claim 17, wherein the SPO estimator is configured to set the value of the SPO state signal to a value indicating that the SPO event occurring is probable while the strength of the wireless power is equal to or greater than the first reference value and the output of the battery is less than a third reference value, wherein the third reference value is less than the second reference value.

19. The mobile device of claim 15, further comprising a power source selector configured to provide one of the output of the battery and an output of the wireless power receiver as a power source of the mobile device in response to the SPO state signal.

20. A method of operating a mobile device, comprising:
detecting a state of at least one of a plurality of power sources of the mobile device, wherein the plurality of power sources are each configured to operate as a driving power source of the mobile device;
determining a probability of a sudden-power-off (SPO) event occurring at a power source from among the plurality of power sources currently operating as the driving power source according to the detected state; and
changing a driving mode of hardware or software of the mobile device according to the determined probability.
